(19) United States
(12) Patent Application Publication
(10) Pub. No.: US 2024/0362693 A1
(43) Pub. Date: Oct. 31, 2024

(54) STORAGE ARRAY RECOMMENDATIONS

(71) Applicant: Dell Products L.P., Round Rock, TX (US)

(72) Inventors: Ashutosh Pandey, Bengaluru (IN); Amod Shankar, Bengaluru (IN); Pankaj Kumar, Patna (IN)

(73) Assignee: Dell Products L.P., Round Rock, TX (US)

(21) Appl. No.: 18/308,967

(22) Filed: Apr. 28, 2023

(51) Int. Cl. G06Q 30/0601; G06N 20/00

(52) U.S. Cl. CPC G06Q 30/0621; G06N 20/00

(57) ABSTRACT

A method for use in a computing system, comprising: receiving a first input identifying a current product configuration, the current product configuration being specified by a user; generating a signature for the current product configuration; executing, based on the signature, a first machine learning model to obtain one or more past product configurations that have been offered to one or more customers by one or more colleagues of the user; and outputting an indication of the one or more past product configurations.

### BACKGROUND

Companies often have to bid on private and public contracts as part of their business model. Bidding on public and private contracts is a complex process, and it is often difficult to predict whether a particular offer will be accepted. For this reason, companies occasionally employ conversion calculators that utilize machine learning to predict whether a particular offer will result in a sale.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method for use in a computing system, comprising: receiving a first input identifying a current product configuration, the current product configuration being specified by a user; generating a signature for the current product configuration; executing, based on the signature, a first machine learning model to obtain one or more past product configurations that have been offered to one or more customers by one or more colleagues of the user; and outputting an indication of the one or more past product configurations.

According to aspects of the disclosure, a system is provided, comprising: a memory; at least one processor that is operatively coupled to the memory, the at least one processor being configured to perform the operations of: receiving a first input identifying a current product configuration, the current product configuration being specified by a user; generating a signature for the current product configuration; executing, based on the signature, a first machine learning model to obtain one or more past product configurations that have been offered to one or more customers by one or more colleagues of the user; and outputting an indication of the one or more past product configurations.

According to aspects of the disclosure, a method is provided for use in a computing system, comprising: receiving a first input identifying a current product configuration, the current product configuration being specified by a user; calculating an estimated salability score for the current product configuration, wherein the estimated salability score is calculated by: (i) generating a signature of the current product configuration or a species of the current product configuration, (ii) obtaining a plurality of weights by executing a first machine learning model based on the signature, and (ii) multiplying each of the plurality of weights by a different numerical value in a plurality of numerical values, the plurality of numerical values corresponding to respective components of one of the current product configuration or the species of the current product configuration, depending on which one of the current product configuration or the species of the current product configuration is used to generate the signature; and outputting an indication of the estimated salability score.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a computing system, according to aspects of the disclosure;

FIG. 1B is a diagram showing an example of a product configuration and a signature for the product configuration, according to aspects of the disclosure.

FIG. 2 is a flowchart of an example of a process, according to aspects of the disclosure;

FIG. 3 is a flowchart of an example of a process, according to aspects of the disclosure;

FIG. 4 is a flowchart of an example of a process, according to aspects of the disclosure;

FIG. 5 is a flowchart of an example of a process, according to aspects of the disclosure;

FIG. 6 is a diagram of an example of a user interface, according to aspects of the disclosure; and

FIG. 7 is a flowchart of an example of a process, according to aspects of the disclosure.

### DETAILED DESCRIPTION

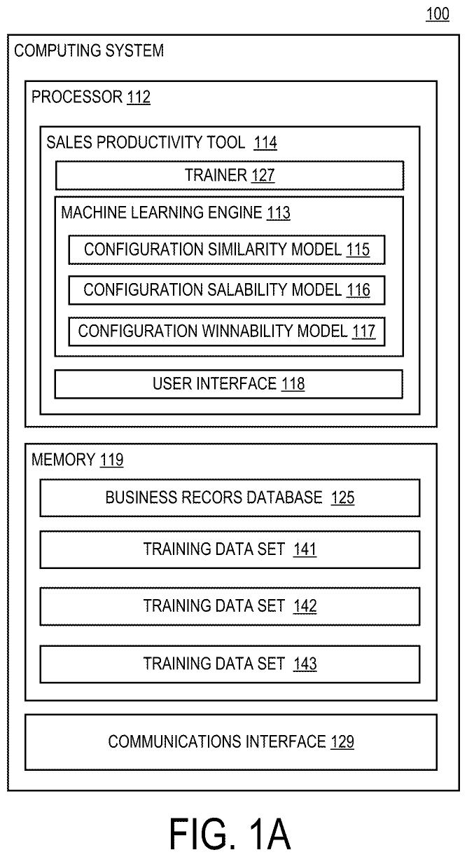

FIG. 1A is a diagram of an example of a computing system 100, according to aspects of the disclosure. The computing system 100 may include a processor 112, a memory 119, and a communications interface 129. The processor 112 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. The memory 119 may include any suitable type of volatile and/or non-volatile memory. In some implementations, the memory 119 may include one or more of a random-access memory (RAM), a dynamic random memory (DRAM), a flash memory, a hard drive (HD), a solid-state drive (SSD), a network accessible storage (NAS), and or any other suitable type of memory device. The communications interface(s) 129 may include any suitable type of communications interface, such as one or more Ethernet adapters, one or more Wi-Fi adapters (e.g., 802.1414 adapters), and one or more Long-Term Evolution (LTE) adapters, for example.

The processor 112 may be configured to execute a sales productivity tool 114. The tool 114 may be used by sales representatives to define a product configuration, which would be afterwards offered for sale to a customer. The tool 114 may be configured to receive a product configuration as input. The tool 114 may analyze the product configuration to produce a salability score for the product configuration. The salability score may be a measure of how likely a customer is to find the product configuration desirable or adequate for the customer's needs. The tool 114 may analyze the product configuration to produce a winnability score for the product configuration. The winnability score may be a measure of how likely a customer is to purchase the product configuration when the customer is presented with a competing product configuration. In other words, the winnability score may indicate how likely the product configuration specified by the sales representative is to score a sale against a competing product configuration from another manufacturer. Or put differently, the winnability is measure of how desirable to a customer is the product configuration in comparison to a product configuration from a competitor. In yet another aspect, the tool 114 may be configured to identify past configurations that are offered for sale by colleagues of the sales representative, thus allowing the sales representative to find what alternatives are available to the product configuration that is specified by the sales representative. The features of tool 114, which are described herein, are advantageous because they can provide sales representatives with an understanding of how a product configuration might perform with a customer, thus enabling the sales representatives to hone in their product configurations before presenting them to customers. Having the opportunity to hone in a particular product configuration is advantageous because it increases the likelihood of the customer purchasing the product configuration.

The salability of a product configuration can be defined in accordance with equation 1 below:

$$Salability = ( \frac{\begin{matrix}number of times the configuration \\ reached preconfiguraton stage\end{matrix}}{number of times a configuration is exported} ) * 100 \qquad ( 1 )$$

According to equation 1, the salability of a product configuration is based on the quotient of the number of times the product configuration was exported and the number of times the product configuration has reached the pre-configuration stage. “Configuration exported” and “pre-configuration” are different stages in the lifecycle of a product configuration. According to the present example, a product configuration is considered exported when the product configuration is presented or offered for sale to a customer. According to the present example, a product configuration is considered to have reached the pre-configuration stage when the customer follows up on the initial presentation with a request for additional information. The request may include one or more of a request for a price quote, a request for available shipping volumes, an inquiry whether a change can be made to the initial product configuration, and/or any other request that is indicative that the customer is considering purchasing the product configuration.

The winnability of a product configuration can be defined in accordance with equation 2 below:

$$Winnability = ( \frac{\# bias won against a compatitor or competing product}{\# bias participate d with a competitor or compet . product} ) * 100 \qquad ( 2 )$$

As quoted, the winnability of a product configuration measures how the product configuration performs against one or more competing products that are offered by a competitor. The winnability of a product configuration may be specific to a specific competitor. Alternatively or additionally, the winnability of a product configuration may be specific to a particular competing product that is offered by the competitor. In this regard, the element labeled as “#bids participated” may be the number of times in which a product configuration was submitted in a bid together with one or more products that are offered by the competitor, and the element labeled as “#bids won” may be the number of those submissions that resulted in a sale. Alternatively, the element labeled as “#bids participated” may be the number of times in which a product configuration was submitted in a bid together with a specific product that is offered by the competitor, and the element labeled as “#bids won” may be the number of those submissions that resulted in a sale.

Stated succinctly, the salability of a product configuration measures the percentage of times in which the product configuration would advance to the pre-configuration stage, and it is agnostic with respect to the competition; it just measures the general attitude that a customer might have to the product configuration. By contrast, the winnability of a product configuration measures the probability of the product configuration being sold to the customer, when the customer is presented with the opportunity of purchasing a specific competing product (or the opportunity to purchase one or more alternative products that are offered by the competition).

Retroactively, both winnability and salability can be determined from records that are maintained by sales representatives. Such records may indicate what product configurations were offered for sale to customers, what competing products or companies the product configurations competed against, whether any of the product configurations reached the pre-configuration stage, and/or whether any of the product configurations ended up being sold to customers. The records may be stored in a database 125, which is maintained in the memory 119.

On the other hand, the winnability and salability for a product configuration cannot be determined proactively in the manner discussed above. For example, a sales representative cannot use equations 1 and 2 to determine the winnability or salability of a product configuration before the product configuration is offered to a customer (or offered to a large number of customers) because no business records would have been created yet for the product configuration. In this regard, the discussion that follows provides systems, methods, and techniques for the proactive determination of the salability and winnability of a product configuration that is being contemplated by a sales representative, but which has not yet been offered to a customer.

FIG. 1B shows an example of a product configuration 120. In the example of FIG. 1B, the product that is being configured is a storage system. However, the present disclosure is not limited to any specific type of product being configured. As illustrated, the product configuration 120 may include components 122, 124, 126, and 128. Each of the components 122, 124, 126, and 128 may specify a different attribute of the product that is being sold. According to the present example, component 122 specifies the name of the product, component 124 specifies the model number of the product, component 126 specifies a type of storage array that the product would be provided with, and component 128 specifies the capacity of the product. Although, the in the example of FIG. 1B, the product configuration 120 includes four components, it will be understood that the present disclosure is not limited to including any specific number of components.

FIG. 1B further shows an example of a signature 130 of the product configuration 120. Signature 130 includes a plurality of portions, wherein each portion in the plurality corresponds to a different component of the product configuration 120. Specifically, in the present example, signature 130 includes portions 132, 134, 136, and 138. Portion 132 is a number that encodes the value of component 122. Portion 132 may be also referred to as “the numerical value of component 122”. Portion 134 is a number that encodes the value of component 124. Portion 134 may be also referred to as “the numerical value of component 124”. Portion 136 is a number that encodes the value of component 126. Portion 136 may be also referred to as “the numerical value of component 126”. Portion 138 is a number that encodes the value of component 128. Portion 138 may be also referred to as “the numerical value of component 128”.

The present disclosure is not limited to any specific method for encoding the value of a product configuration component. For example, in some implementations, the tool 114 may use a map (stored in memory 119), which maps each possible value of a component to a corresponding numerical value. Such map may provide that model “PowerMax™” corresponds to numerical value ‘1’, model “PowerStore™” corresponds to numerical value ‘2’, and a selection of both “PowerMax™” and “PowerStore™” corresponds to numerical value ‘3’. As another example, when the value of a component includes a number, that number may be considered to be the numerical value of the component. For instance, component 128 includes the number 1.3Tbe, and accordingly “1.3” may be considered the numerical value of the component.

Equation 3 below presents an alternative method for calculating the salability of the product configuration 120 (or any other product configuration).

$$Salability = {\sum }_{i = 1}^{n} {w}_{i} * {c}_{i} \qquad ( 3 )$$

Where n is the number of components that are present in product configuration 120, i is an integer, cᵢ is the numerical value of the i-th component of the product configuration 120 (or any other product configuration), and wᵢ is a weight that is assigned to the i-th component of the product configuration 120 (or any other product configuration). According to the present disclosure, the set of weights w is determined by classifying the signature 130 with a configuration salability model 116 of the tool 114.

Equation 4 below presents an alternative method for calculating the salability of the product configuration 120 (or any other product configuration).

$$Winnability = {\sum }_{i = 1}^{n} {k}_{i} * {c}_{i} \qquad ( 4 )$$

Where n is the number of components that are present in product configuration 120, i is an integer, cᵢ is the numerical value of the i-th component of the product configuration 120 (or any other product configuration), and kᵢ is a weight that is assigned to the i-th component of the product configuration 120 (or any other product configuration). According to the present disclosure, the set of weights k is determined by classifying the signature 130 with a configuration winnability model 117 of the tool 114.

In some respects, equations 3 and 4 may be used to pro-actively determine the salability and winnability scores of product configuration 120, before the product configuration 120 is offered for sale to any customer. In other words, equations 3 and 4 may be used to determine the salability and winnability scores for product configuration 120 when no records are available for product configuration 120 that show how the product configuration has fared in the past with customers, or how product configuration 120 has fared against a particular competitor or competing product.

Returning to FIG. 1A, the tool 114 may include a trainer 127, a machine learning engine 113, and a user interface 118. The machine learning engine 113 may include software (and/or hardware) that is configured to execute a configuration similarity model 115, a configuration salability model 116, and a configuration winnability model 117.

The model 115 may be configured to receive as input the signature of a product configuration and output a list of sales associates that have sold, in the past, product configurations that are similar to the product configuration. The model 115 may be used by a junior sales representative to identify colleagues who have experience in selling product configurations that are similar to a product configuration that is being contemplated (or prepared) by the junior sales representative. Afterwards, the junior sales representative can review different past product configurations that have been offered for sale to customers by the colleagues. In addition, the junior sales representative may find the salability and winnability scores for the past product configuration, to see how they have fared with customers and/or against the competition.

The model 115 may implement one or more of a neural network, a decision tree, a support vector machine, a logistic regression predictor, a linear regression predictor, a single value decomposition (SVD) predictor, and/or any other machine learning model. In some implementations, for each of the plurality of colleagues of a sales representative, the model 115 may classify the signature into one of a first category and a second category. When a signature is classified into the first category, this may indicate that the colleague has sufficient experience in selling product configurations that are similar to the product configuration whose signature is being classified. When the signature is classified into the second category, this may indicate that the colleague does not have sufficient experience in selling product configurations that are similar to the product configuration whose signature is being classified.

The model 115 may be trained by the trainer 127 by using a supervised learning algorithm. The supervised learning algorithm may use a training data set 141. The training data set may include a plurality of entries. Each entry may include a respective product configuration signature, and a label identifying one or more colleagues (i.e., sales representatives) who have experience in selling products that are similar to the product configuration that is represented by the signature. It will be understood that the present disclosure is not limited to using any specific training algorithm or training data set for training the model 115.

Alternatively, the model 115 may be configured to receive as input the signature of a current product configuration and output a list of past product configurations that are similar to the current product configuration. The past product configurations may include product configurations that have been offered for sale by the same company in the past (i.e., the company using tool 114). In some implementations, for each of the plurality of past product configurations, the model 115 may classify the signature of the current product configuration into one of a first category and a second category. When a signature is classified into the first category, this may indicate that the past product configuration is similar to the current product configuration. When the signature is classified into the second category, this may indicate that the past product configuration is not sufficiently similar to the current product configuration.

In the latter example, the model 115 may be trained by the trainer 127 by using a supervised learning algorithm. The supervised learning algorithm may use a training data set 141. The training data set may include a plurality of entries. Each entry may include a respective product configuration signature, and a label identifying one or more past product configurations (i.e., sales representatives) that are similar to the product configuration represented by the signature. It will be understood that the present disclosure is not limited to using any specific training algorithm or training data set for training the model 115.

Model 116 may be configured to receive as input the signature of a product configuration and output a set of weights in response. The set of weights may be the same or similar as the set of weights w which is discussed above with equation 3. The model 116 may implement one or more of a neural network, a decision tree, a support vector machine, a logistic regression predictor, a linear regression predictor, a single value decomposition (SVD) predictor, and/or any other machine learning model. In some implementations, the model 116 may be trained by trainer 127 based on a training data set 142. The training data set 142 may include a plurality of entries. Each entity may include a respective a product configuration signature and a label that identify a set of weights w, wherein each weight wᵢ in the set w corresponds to a different component of the product configuration. Although, in the present example, the model 116 is trained by using supervised learning, it will be understood that the present disclosure is not limited to any specific training data set or algorithm for training the model 116.

Model 117 may be configured to receive as input the signature of a product configuration and output a set of weights in response. The set of weights may be the same or similar as the set of weights k which is discussed above with equation 4. The model 117 may implement one or more of a neural network, a decision tree, a support vector machine, a logistic regression predictor, a linear regression predictor, a single value decomposition (SVD) predictor, and/or any other machine learning model. In some implementations, the model 117 may be trained by trainer 127 based on a training data set 143. The training data set 143 may include a plurality of entries. Each entity may include a respective a product configuration signature and a label that identifies a set of weights k, wherein each weight kᵢ in the set k corresponds to a different component of the product configuration. Although in the present example, the model 116 is trained by using supervised learning, it will be understood that the present disclosure is not limited to any specific training data set or algorithm for training the model 117.

In some implementations, machine learning engine 113 may include a plurality of instances of the model 117, where each instance corresponds to a different respective competing product. In such implementations, each instance of the model 117 may be trained based on a different training data set 143, which is specific to the instance's corresponding competing product. Additionally or alternatively, in some implementations, machine learning engine 113 may include a plurality of instances of the model 117, where each instance corresponds to a different respective competitor (i.e., a different respective company that sells competing products). In such implementations, each instance of the model 117 may be trained based on a different training data set 143, which is specific to the instance's corresponding competitor. As noted above, the winnability score for a product configuration may indicate how the product configuration would fair in competition against a specific competing product or any product that is offered by a specific competitor. Accordingly, this may necessitate training a different respective model instance for each of a plurality of competitors or competing products.

The memory 119 may be configured to store a database 125, as well as the training data sets 141, 142, and 143. The database 125 may include business records for each of a plurality of past product configurations. Each of the past product configurations may be product configuration that has been offered for sale to a customer in the past. The business records for each of the past configurations may identify, the number of offers for sale of the product configurations that have been made, whether each of the offers reached the pre-configuration stage, whether each of the offers was presented in competition with a particular competitor or a particular competing product configuration, whether any of the offers resulted in a sale. The business records that are present in database 125 may be used by trainer 127 to generate training data sets 141, 142, and 143.

Although the computing system 100 is depicted as an integrated computing system, alternative implementations are possible in which the computing system 100 is a distributed computing system. In such implementations, the computing system 100 may include a plurality of computing devices that are connected to each other via a communications network. Although the database 125 and the training data sets 141-143 are stored in the memory 119 of the computing system 100, it will be understood that any of the database 125 and the data sets 141-143 is stored remotely. Although, in the example of FIG. 1, the trainer 127, machine learning engine 113, and user interface 118 are executed on the same computing device, it will be understood that any of the trainer 127, the machine learning engine 113, and the user interface 118 are executed on different computing devices.

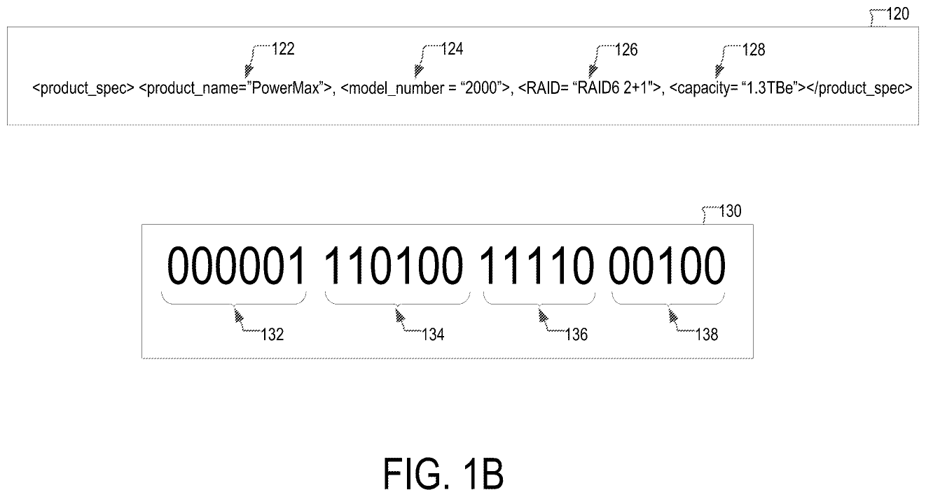

FIG. 2 is a flowchart of an example of a process 200, according to aspects of the disclosure.

At step 202, the tool 114 detects a first input from a user that specifies a current product configuration. The current product configuration may be the same or similar to the product configuration 120, which is discussed above with respect to FIG. 1B.

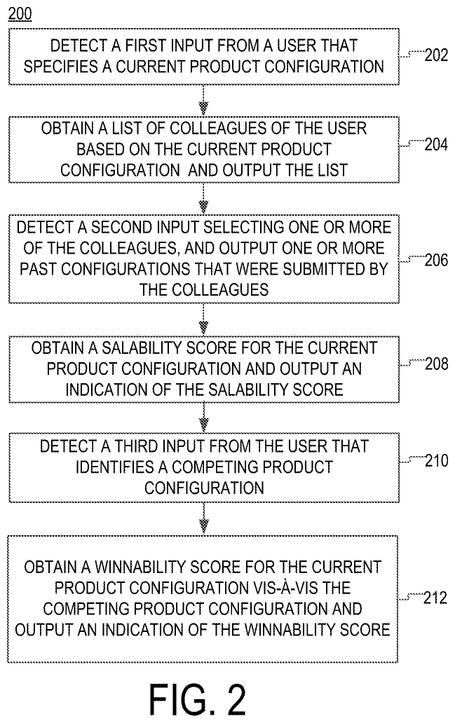

At step 204, the tool 114, obtains a list of colleagues of the user based on the current product configuration. After the list is obtained, the tool 114 outputs the list. Outputting the list may include displaying the list on a display device, transmitting the list over a communications network, and/or any other suitable action that results in the list being presented to the user. Step 204 may be performed in accordance with the process 300, which is discussed further below with respect to FIG. 3.

At step 206, the tool 114 detects a second input from the user, which selects one or more of the colleagues of the user from the list. In response to the second input, the tool 114 identifies a plurality of past product configurations that are transmitted by the selected colleagues. The past product configurations may be obtained from the database 125. After the past product configurations are obtained, they may be output for presentation to the user. As noted above, outputting the past configurations may include displaying the list on a display device or transmitting the list over a communications network.

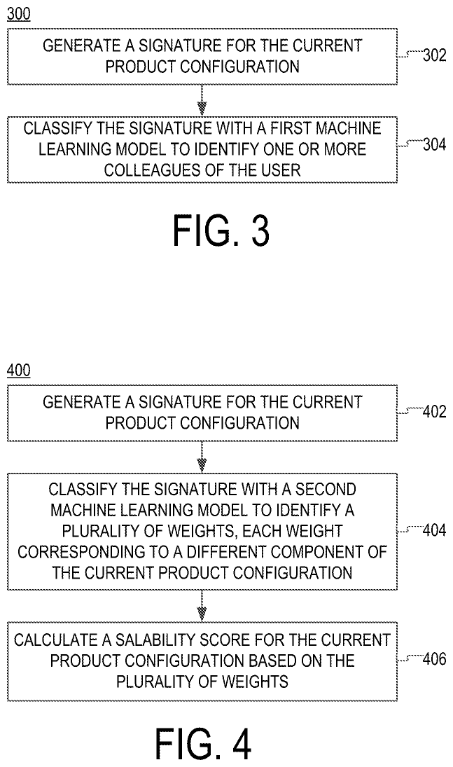

At step 208, the tool 114 obtains a salability score for the current product configuration and outputs the obtained salability score. Step 208 may be performed in accordance with the process 400, which is discussed further below with respect to FIG. 4.

At step 210, the tool 114 detects a third input from the user that identifies one or more competing product configurations. Although, in the present example, the third input specifies a competing product configuration, alternative implementations are possible in which the third input identifies a particular competitor, without specifically identifying any products that are marketed by the competitor.

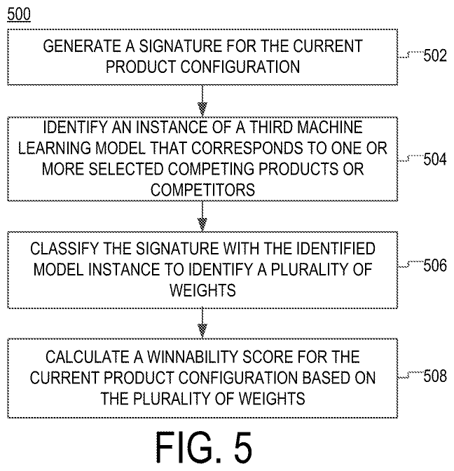

At step 212, the tool 114 obtains a winnability score for the product vis-a-vis the competing product or competitor (obtained at step 210). After the winnability score is obtained, the winnability score is output for presentation to the user. Outputting the winnability score may include displaying the winnability score on a display device or transmitting the winnability score over a communications network. Step 212 may be performed in accordance with the process 500, which is discussed further below with respect to FIG. 5

FIG. 3 is a flowchart of an example of a process 300 for obtaining a list of colleagues of a user, as specified by step 204 of the process 200. At step 302, the tool 114 generates a signature for the product configuration (received at step 202). In some implementations, the signature may be the same or similar to the signature 130, which is discussed above with respect to FIG. 1B. At step 304, the tool 114 classifies the signature with the model 115 to identify one or more colleagues of the user. Specifically, the tool 114 executes the model 115 based on the signature and obtains a list of the user's colleagues as a result of the execution.

FIG. 4 is a flowchart of an example of a process 400 for obtaining a salability score for a current product configuration, as specified by step 208 of the process 200. At step 402, the tool 114 generates a signature for the product configuration (received at step 202). In some implementations, the signature may be the same or similar to the signature 130, which is discussed above with respect to FIG. 1B. Additionally or alternatively, in some implementations, the signature may be the same as or different than the signature generated at step 302. At step 404, the tool 114 classifies the signature with the model 116 to identify a set of weights w. Each weight wᵢ in the set w may correspond to a different component of the current product configuration. At step 406, the tool 114 calculates the salability score for the current product configuration by evaluating equation 3 based on the set of weights w (obtained at step 404).

FIG. 5 is a flowchart of an example of a process 500 for obtaining a winnability score for the current product configuration, as specified by step 212 of the process 200.

At step 502, the tool 114 generates a signature for the current product configuration (received at step 202). In some implementations, the signature may be the same or similar to the signature 130, which is discussed above with respect to FIG. 1B. Additionally or alternatively, in some implementations, the signature may be the same as or different than any of the signatures generated at steps 302 and 402.

At step 504, the tool 114 identifies an instance of the model 117 that corresponds to the product configuration (or competitor) that is specified at step 210 of the process 200. In some implementations, the memory 119 may store a database (not shown). The database may include a plurality of entries. Each entry may include an identifier of a different instance of model 117. In addition, each entry may include an identifier of a competing product or a competitor that is associated with the entry's model 117 instance. In this regard, identifying the instance of model 117 that is associated with the competing product (identified at step 210) may include performing a search of the database to identify an entry that includes an identifier of the competing product that is specified at step 210 and retrieving the identifier of model 117 instance from the identified entry.

At step 506, the tool 114 classifies the signature with the instance of model 117 (obtained at step 504) to identify a set of weights k. Each weight kᵢ in the set k may correspond to a different component of the current product configuration.

At step 508, the tool 114 calculates the winnability score for the current product configuration by evaluating equation 4 based on the set of weights k (obtained at step 506).

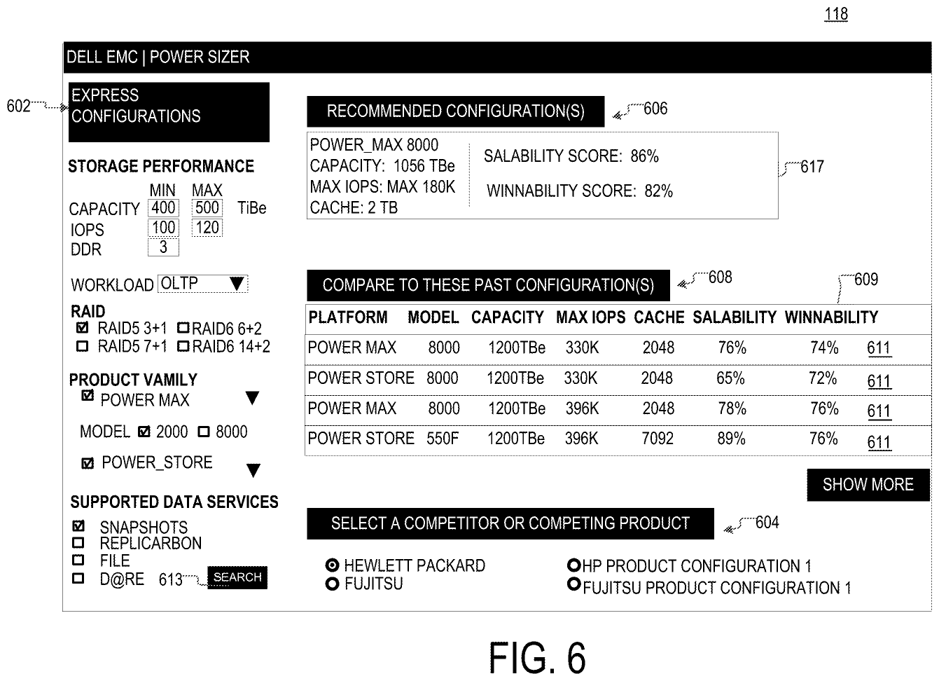

FIG. 6 is a diagram of the user interface 118 (shown in FIG. 1), according to aspects of the disclosure. In the example of FIG. 6, the user interface includes portions 602, 604, 606, and 608. In the example of FIG. 6, the user interface 118 is arranged to specify and analyze the product configuration for a storage system. However, the present disclosure is not limited to any specific type of product being specified or analyzed with the user interface 118.

Portion 602 may be used by user interface 118 to receive a user input specifying a product configuration. Portion 602 may include a plurality of input components for specifying the values of various components of a product configuration. The product configuration that is specified with portion 602 is herein referred to as “current product configuration”. By way of example, the current product configuration may be a configuration that has not been offered for sale to a user before and/or a configuration for which sufficient data is not available to determine how a customer might respond to it or how the current product configuration may fare in competition with a competing product or competitor. As noted above, the current product configuration is a configuration of a storage system. In this regard, portion 602 may include any of: (i) one or more input components for specifying a range for the storage capacity of the storage system, (ii) one or more input components for specifying a range for the I/Os per second (IOPS) of the storage system, (iii) one or more input components for specifying the type of random access memory of the storage system, (iv) one or more input components for specifying the type of workload which the storage system is going to be subjected to, (v) one or input components for specifying the type of redundant array of independent disks (RAID) that is going to be used by the storage system, (vi) one or more input component for specifying a product family and/or a model number for the storage system, and (iv) one or more input components for specifying data services that need to be supported by the storage system.

In one aspect, FIG. 6 illustrates that a component of a product configuration that is specified with portion 602 may include a single value for an attribute of the product or it may include a range of values for the attribute. In this regard, a product configuration may identify an individual product or a genus of products whose attributes fall within the attribute ranges of the product configuration. Under the nomenclature of the present disclosure, when a product configuration specifies a single product, that product is said to be “associated with the product configuration.” When the product configuration specifies a genus of products, any product that is part of the genus is said to be “associated with the product configuration”. According to the present disclosure, a product configuration is offered for sale when any product associated with the product configuration is offered for sale. According to the present disclosure, a product configuration is sold to a customer when the customer purchases any product that is associated with the product configuration.

Consider an example of a first product configuration that is defined as follows {“cache=1-2 TB”, “IOPS=180K,” and “capacity=1-2TBe”}. Consider also that a second product configuration may be defined as follows {“cache=1 TB”, IOPS=“180K” and “capacity=1.5TBe”}. Consider also a third product configuration that is defined as follows {cache=1.5 TB, IOPS=180K, and capacity=1.5 TB″}. In this example, the first product configuration has a genus of products that are associated with it, whereas the second and third product configurations each have a single product that is specified by them. The value of each component of the second and third configurations is equal to or falls into the range of the value(s) for the same component in the first product configuration. For this reason, the second and third product configurations are considered to be species of the first product configuration.

The phrase “executing a machine learning model based on a first product configuration” may refer one or both of (i) “executing the machine learning model based on a signature of the first product configuration and/or (ii) “identifying a second product configuration that is species of the first configuration and executing the machine learning model based on a signature of the second product configuration”.

Portion 604 includes one or more products for selecting a specific competitor or a specific product that is sold by a competitor.

In operation, when the user has provided input into portions 602 and 604, the user may press the search button 613. Next, the tool 114 may detect that the button 613 has been pressed. Next, the tool 114 may identify one or more products that are associated with the product configuration specified in portion 602. The one or more products may be identified by searching a product database (not shown) that is stored in memory 119 and identifying products that possess the attributes specified by the current product configuration. Next, for each of the identified products, the tool 114 may display a respective product descriptor 617 in portion 606. Next, the tool 114 may identify a plurality of past product configurations that are similar to the current configuration. And finally, the tool 114 may display a list 609 of the past configurations in portion 608.

Portion 606 may include a descriptor 617 of a product that is associated with the current product configuration. Although, in the present example, portion 606 includes only one descriptor 617, alternative implementations are possible in which portion 606 includes multiple descriptors 617 of different products that correspond to the current product configuration. As illustrated, descriptor 617 may include an identifier of a product that is associated with the current product configuration (e.g., POWER_MAX 800), as well as the values of one or more attributes of the product, such as capacity, max IOPS, cache size, etc.

The descriptor 617 may include a salability score for the product. The salability score may be calculated by the tool 114 in response to the search button being pressed. The salability score may be generated based on a signature of the current product configuration. Alternatively, the salability score may be generated based on a signature corresponding to the product configuration of the product that is identified in descriptor 617 (i.e., based on a product configuration that is a species of the current product configuration). The salability score may be generated in accordance with the process 400, which is discussed above with respect to FIG. 4. In this regard, the salability score that is provided in descriptor 617 may be an estimate or projection.

The descriptor 617 may include a winnability score for the product. The winnability score may be calculated by the tool 114 in response to the search button being pressed. The winnability score may be generated based on the current product signature. Alternatively, the winnability score may be generated based on a signature corresponding to the product configuration of the product identified in descriptor 617 (i.e., based on a product signature that is a species of the current product configuration). The winnability score may be generated in accordance with the process 500, which is discussed above with respect to FIG. 5. The winnability score in descriptor 617 may correspond to a competitor or competing product that is specified via user input received in portion 604 of the user interface 118. In this regard, the winnability score may be specific to the competing product or competitor that is specified in portion 604 of the user interface 118.

Portion 608 may include a list 609. The list 609 may include a plurality of entries 611. Each entry 611 may be associated with a different one of a plurality of past product configurations. The plurality of past product configurations may be identified by the tool 114 in response to the search button 613 being pressed. Each entry 611 may include an identifier of the entry's corresponding past product configuration and/or an indication of one or more attributes of the entry's respective product configuration. Each entry 611 may include a respective salability score and a respective winnability score for the entry's product configuration. The respective winnability and salability scores in each entry 611 may be calculated based on historical records that are part of database 125 by using equations 1 and 2, respectively. In this regard, the winnability and salability scores in each entry 611 are actual salability and winnability scores (rather than being estimates like the winnability and salability scores in product descriptor 617). The winnability score in each entry 611 may correspond to a competitor or competing product that is specified via user input received in portion 604 of the user interface 118. In this regard, the winnability score may be specific to the competing product or competitor that is specified in portion 604 of the user interface 118.

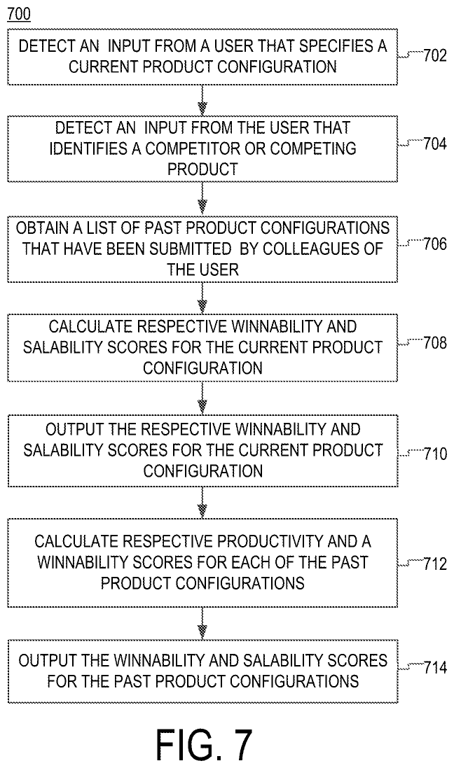

FIG. 7 is a flowchart of an example of a process 700, according to aspects of the disclosure.

At step 702, the tool 114 detects an input from a user that specifies a current product configuration. According to the present example, the input is received via portion 602 of the user interface 118.

At step 704, the tool 114 detects an input from the user that identifies a competitor or competing product. According to the present example, the input is received via portion 604 of the user interface 118.

At step 706, the tool 114 obtains a list of past product configurations. In some implementations, the list may be obtained by executing the model 115 based on a signature of the current product configuration. Alternatively, the list may be obtained in the manner discussed above with respect to steps 204 and 206 of the process 200.

At step 708, the tool 114 calculates respective winnability and salability scores for the current product configuration. The respective salability score may be calculated by executing the process 400, which is discussed above with respect to FIG. 4. The respective winnability score may be calculated by executing the process 500, which is discussed above with respect to FIG. 5. The respective winnability score may correspond to the competing product or competitor that is identified at step 704.

At step 710, the tool 114 outputs the salability and winnability scores of the current product configuration in portion 606 of the user interface 118.

At step 712, the tool 114 calculates the respective winnability and salability scores for each of the past product configurations. The respective winnability and salability scores may be calculated in the manner discussed above with respect to FIG. 6. The respective winnability scores may correspond to the competing product or competitor that is identified at step 704.

At step 714, the tool 114 outputs the winnability and salability scores for each of the past product configurations. The winnability and salability scores for the past configurations may be displayed in portion 608 of the user interface 118. In some implementations, that winnability and salability scores may be displayed in a list, such as the list 609, which includes additional information about the past product configurations.

FIGS. 1A-7, are provided as an example only. At least some of the steps discussed with respect to FIGS. 1A-7 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method for use in a computing system, comprising:
receiving a first input identifying a current product configuration, the current product configuration being specified by a user;
generating a signature for the current product configuration;
executing, based on the signature, a first machine learning model to obtain one or more past product configurations that have been offered to one or more customers by one or more colleagues of the user; and
outputting an indication of the one or more past product configurations.

2. The method of claim 1, wherein:
the first machine learning model is configured to receive the signature as input and output a list of colleagues of the user, the first machine learning model being configured to classify the current product configuration as either related or unrelated to each of a plurality of colleagues of the user, and
the one or more past product configurations are product configurations that have been offered for sale to customers by the colleagues of the user.

3. The method of claim 1, wherein the first machine learning model is configured to receive the signature as input and output a list of past product configurations that correspond to the current product configuration.

4. The method of claim 1, further comprising:
obtaining a plurality of weights by executing a second machine learning model based on the current product configuration or a species of the current product configuration; and
calculating an estimated salability score for the current product configuration based on the plurality of weights, the estimated salability score being indicative of a likelihood of the current product configuration being satisfactory to a customer, the estimated salability score being calculated by multiplying each of the plurality of weights by a different one of a plurality of numerical values, the plurality of numerical values being associated with either components of the current product configuration or components of the species of the current product configuration, depending on whether the second machine learning model is executed based on the current product configuration or the species of the current product configuration; and
outputting an indication of the estimated salability score.

5. The method of claim 4, wherein the estimated salability score is calculated in accordance with the equation of:
$$Salability Score = {\sum }_{i = 1}^{n} {w}_{i} * {f}_{i}$$
where i is an integer, wᵢ is the i-th weight in the plurality of weights, and fᵢ is a numerical value of a component of the current product configuration or the species of the current product configuration.

6. The method of claim 1, further comprising:
receiving a second input identifying a competitor or competing product;
obtaining a plurality of weights by executing a second machine learning model based on the current product configuration or a species of the current product configuration;
calculating an estimated winnability score for the current product configuration vis-a-vis the competitor or competing product, the estimated winnability score being calculated by multiplying each of the plurality of weights by a different one of a plurality of numerical values, the plurality of numerical values being associated with either components of the current product configuration or components of the species of the current product configuration, depending on whether the second machine learning model is executed based on the current product configuration or the species of the current product configuration; and
outputting an indication of the estimated winnability score.

7. The method of claim 1, wherein the current product configuration includes a storage system configuration.

8. A system, comprising:
a memory;
at least one processor that is operatively coupled to the memory, the at least one processor being configured to perform the operations of:
receiving a first input identifying a current product configuration, the current product configuration being specified by a user;
generating a signature for the current product configuration;
executing, based on the signature, a first machine learning model to obtain one or more past product configurations that have been offered to one or more customers by one or more colleagues of the user; and
outputting an indication of the one or more past product configurations.

9. The system of claim 8, wherein:
the first machine learning model is configured to receive the signature as input and output a list of colleagues of the user, the first machine learning model being configured to classify the current product configuration as either related or unrelated to each of a plurality of colleagues of the user, and
the one or more past product configurations are product configurations that have been offered for sale to customers by the colleagues of the user.

10. The system of claim 8, wherein the first machine learning model is configured to receive the signature as input and output a list of past product configurations that correspond to the current product configuration.

11. The system of claim 8, wherein the at least one processor is further configured to perform the operations of:
obtaining a plurality of weights by executing a second machine learning model based on the current product configuration or a species of the current product configuration; and
calculating an estimated salability score for the current product configuration based on the plurality of weights, the estimated salability score being indicative of a likelihood of the current product configuration being satisfactory to a customer, the estimated salability score being calculated by multiplying each of the plurality of weights by a different one of a plurality of numerical values, the plurality of numerical values being associated with either components of the current product configuration or components of the species of the current product configuration, depending on whether the second machine learning model is executed based on the current product configuration or the species of the current product configuration; and
outputting an indication of the estimated salability score.

12. The system of claim 11, wherein the estimated salability score is calculated in accordance with the equation of:
$$Salability Score = {\sum }_{i = 1}^{n} {w}_{i} * {f}_{i}$$
where i is an integer, wᵢ is the i-th weight in the plurality of weights, and fᵢ is a numerical value of a component of the current product configuration or the species of the current product configuration.

13. The system of claim 8, wherein the at least one processor is further configured to perform the operations of:
receiving a second input identifying a competitor or competing product;
obtaining a plurality of weights by executing a second machine learning model based on the current product configuration or a species of the current product configuration;
calculating an estimated winnability score for the current product configuration vis-a-vis the competitor or competing product, the estimated winnability score being calculated by multiplying each of the plurality of weights by a different one of a plurality of numerical values, the plurality of numerical values being associated with either components of the current product configuration or components of the species of the current product configuration, depending on whether the second machine learning model is executed based on the current product configuration or the species of the current product configuration; and
outputting an indication of the estimated winnability score.

14. The system of claim 8, wherein the current product configuration includes a storage system configuration.

15. A method for use in a computing system, comprising:
receiving a first input identifying a current product configuration, the current product configuration being specified by a user;
calculating an estimated salability score for the current product configuration, wherein the estimated salability score is calculated by: (i) generating a signature of the current product configuration or a species of the current product configuration, (ii) obtaining a plurality of weights by executing a first machine learning model based on the signature, and (ii) multiplying each of the plurality of weights by a different numerical value in a plurality of numerical values, the plurality of numerical values corresponding to respective components of one of the current product configuration or the species of the current product configuration, depending on which one of the current product configuration or the species of the current product configuration is used to generate the signature; and
outputting an indication of the estimated salability score.

16. The method of claim 15, further comprising:
executing a second machine learning model based on the current product configuration to obtain one or more past product configurations that have been offered to one or more customers by one or more colleagues of the user; and
outputting an indication of the one or more past product configurations.

17. The method of claim 15, further comprising calculating an estimated winnability score for the current product configuration or the species of the current product configuration and outputting an indication of the estimated winnability score.

18. The method of claim 15, wherein the estimated salability score is calculated based on the equation of:
$$Salability Score = {\sum }_{i = 1}^{n} {w}_{i} * {f}_{i}$$
where i is an integer, wᵢ is the i-th weight in the plurality of weights, and fᵢ is a numerical value of a configuration component of the current product configuration or the species of the current product configuration.

19. The method of claim 15, wherein the signature is generated based on the current product configuration, and each of the plurality of numerical values is a numerical value of a different component of the current product configuration.

20. The method of claim 15, wherein the signature is generated based on the species of the current product configuration, and each of the plurality of numerical values is a numerical value of a different component of the species of the current product configuration.
